(19) United States
(12) Patent Application Publication
(10) Pub. No.: US 2020/0329085 A1
(43) Pub. Date: Oct. 15, 2020

(54) REAL-TIME VIDEO NOTIFICATION METHOD AND REAL-TIME VIDEO NOTIFICATION SYSTEM FOR TRANSPORTATION VEHICLE

(71) Applicant: RIGO GLOBAL CO., LTD., New Taipei City (TW)

(72) Inventor: Chien-Chang LIN, New Taipei City (TW)

(73) Assignee: RIGO GLOBAL CO., LTD., New Taipei City (TW)

(21) Appl. No.: 16/379,557

(22) Filed: Apr. 9, 2019

(51) Int. Cl. H04L 29/06; H04L 29/08; H04W 76/14

(52) U.S. Cl. CPC H04L 65/4069; H04L 67/10; G07C 5/008; H04L 67/20; H04W 76/14

(57) ABSTRACT

A real-time video notification method for a transportation vehicle is executed by a real-time video notification system, and the real-time video notification method includes steps of: pairing an electronic device with a cloud server; capturing in-transportation-vehicle images; and transmitting the real-time video information and the position signal to the cloud server. The real-time video notification system includes a cloud server and an electronic device, wirelessly communicating with the cloud server. The electronic device includes a central processing unit (CPU), electrically connected to a camera module, a position module, an emergency button, and a wireless transmission circuit. The real-time video notification method and the real-time video notification system facilitate a driver or a passenger to seek help on their own as soon as possible in case of emergency.

### BACKGROUND OF THE INVENTION

### 1. Field of the Invention

The present invention relates to a real-time video notification method and a real-time video notification system for a transportation vehicle, and more particularly to a method and a system including a camera module and a wireless transmission circuit for recording status of a vehicle in an emergency or non-emergency situation, and for transmitting a distress signal to seek assistance.

### 2. Description of the Related Art

As a common means of transportation, vehicles such as taxis are very convenient, facilitating many passengers who do not own personal vehicles to conveniently travel for business, vacations, or other visits. No matter whether the passengers temporary hail the transportation vehicle or purposefully pre-book the transportation vehicle, the passengers without personal vehicles can efficiently find the travel vehicles, and such convenience maintains the high demand for these transportation vehicles.

In recent years, Uber is a new emerging transportation service. The unique business method of the Uber has attracted crowd's attention, and many passengers have switched from the general transportation service to the Uber's service. Therefore, the volume of the Uber service has increased.

Whatever the ride service is from traditional taxi or the Uber vehicles, unexpected emergent event may happen anytime, such as a car accident, a malfunction of a vehicle, or a conflict between the passenger and a driver. Especially in the past few years, criminal cases have been frequently reported. In some cases, the passengers are attacked and even killed by the driver, or the driver is beaten and seriously injured by the passengers. Moreover, when the passenger or the driver encounters an emergent situation, the event normally can be recorded to voice segments through a driving recorder device, or rely on retelling of a witness who happens to pass by and help the victim. Nowadays, these ways and vehicle equipment can't satisfy the need of instant and security for people such as the passenger or the driver, is extremely difficult to collect evidences of the emergency on their own. In addition, when the victim is subjected to more serious attacks, the victim cannot immediately seek help on the spot, but can only do so afterwards. Therefore, a helper usually misses the first time to rescue the victim, which causes irretrievable result.

### SUMMARY OF THE INVENTION

An objective of the present invention is to protect the safety of the passengers and the drivers in a transportation vehicle, and to quickly seek help while encountering an emergency. The present invention provides a real-time video notification method and a real-time video notification system for the transportation vehicle. The present invention enables a passenger's mobile phone to communicate with a cloud server and an electronic device on the transportation vehicle, and the passenger's mobile phone can enable a video recording function of the electronic device. When the passengers or the drivers encounter the emergent event, the passengers and the drivers both can instantly seek help by triggering alert button through the passenger's mobile phone or the electronic device.

In order to achieve the above objective, the real-time video notification method for the transportation vehicle includes steps of:

(a1) pairing an electronic device with a cloud server; wherein the electronic device transmits a first pair signal to the cloud server, and the cloud server authorizes pairing information of the electronic device according to the first pair signal; wherein when the cloud server determines that the pairing information of the electronic device is authorized, the electronic device is paired with the cloud server;

(a2) capturing in-transportation-vehicle images; wherein when an emergency button of the electronic device is activated, the electronic device enables a camera module of the electronic device to capture the in-transportation-vehicle images to generate real-time video information, and the electronic device receives the real-time video information from the camera module; wherein the electronic device further generates a position signal when the emergency button is activated;

(a3) transmitting the real-time video information and the position signal to the cloud server; wherein when the emergency button is activated, the electronic device transmits the real-time video information and the position signal to the cloud server.

Another real-time video notification method for the transportation vehicle of the present invention includes steps of:

(b1) pairing a cloud server with an electronic device and a user device; wherein the electronic device transmits a first pair signal to the cloud server, and the cloud server authorizes device pairing information of the electronic device according to the first pair signal; wherein when the cloud server determines that the device pairing information of the electronic device is authorized, the electronic device is paired with the cloud server; wherein the user device transmits a second pair signal to the cloud server, and the cloud server authorizes user pairing information of the user device according to the second pair signal; wherein when the cloud server determines that the user pairing information of the user device is authorized, the user device is paired with the cloud server;

(b2) setting a third-party device; wherein the third-party device is set by sub-steps of:
(b21) setting contact information of the third-party device; wherein the user device transmits the contact information of the third-party device to the cloud server;
(b22) transmitting login information to the third-party device; wherein the cloud server receives the contact information, and the cloud server transmits the login information to the third-party device;
(b23) logging in the cloud server; wherein the third-party device receives the login information, and the third-party device logs in the cloud server according to the login information; and
(b24) notifying the user device that the third-party device is paired with the cloud server; wherein when the cloud server determines that the third party device successfully logs in the cloud server, the cloud server transmits a successful paired signal to the user device for notifying the user device that the third party device is paired with the cloud server; and

(b3) transmitting real-time video information to the third party device; wherein when the user device transmits a video sharing signal to the cloud server, the cloud server transmits an enabling signal to the electronic device, and the electronic device enables a camera module of the electronic device to capture in-transportation-vehicle images to generate the real-time video information according to the enabling signal; wherein the electronic device transmits the real-time video information to the cloud server, the cloud server transmits the real-time video information to the third party device, and the third party device displays the real-time video information.

The real-time video notification system for the transportation vehicle includes:

a cloud server;

an electronic device, wirelessly communicating with the cloud server; wherein the electronic device includes:

a central processing unit (CPU);

a camera module, electrically connected to the CPU to capture in-transportation-vehicle images, and generating real-time video information;

an authorizing module, electrically connected to the CPU to generate a first pair signal, and transmitting the first pair signal to the could server; wherein the cloud server receives the first pair signal, and the cloud server authorizes device pairing information of the electronic device according to the first pair signal;

a position module, electrically connected to the CPU to generate a position signal;

an emergency button, electrically connected to the CPU; wherein when the emergency button is activated, the CPU enables the camera module to capture the in-transportation-vehicle images;

a wireless transmission circuit, electrically connected to the CPU, and wirelessly connecting the electronic device with the cloud server; wherein when the emergency button is activated, the electronic device transmits the real-time video information, the first pair signal, and the position signal to the cloud server through the wireless transmission circuit.

Since the electronic device includes the camera module and the position module, the electronic device can capture the in-transportation-vehicle images to generate the real-time video information while moving, and the electronic device can transmit the real-time video information and the position signal generated by the position module to the cloud server. The cloud server can further notify a rescue team for help. For example, when the driver encounters an emergency caused by the passengers, the electronic device can notify the rescue team, such as the police, through the cloud server, and the police can arrive to handle or eliminate disputes as soon as possible.

The electronic device and the cloud server can further communicate with the user device. For example, when the passenger encounters an emergency caused by the driver, the user device can activate the camera module of the electronic device, and the camera module can capture the in-transportation-vehicle images to record processes of the emergency. Further, the electronic device can transmit the real-time video information and the position signal to the cloud server for notifying the rescue team, and the rescue team can arrive at the scene of the emergency to help the passengers.

The present invention further provides a function that a third party, other than the driver and the passenger, can watch the in-transportation-vehicle images. The camera module can capture the in-transportation-vehicle images to generate the real-time video information, and the real-time video information can be transmitted to the third-party device. Therefore, the third party can watch the real-time images in the transportation vehicle through the third-party device. When the driver or the passenger encounters the emergency, such as a passenger getting injured in a car accident, the third party can notify the rescue team to seek help for the driver or the passenger.

### BRIEF DESCRIPTION OF THE DRAWINGS

FIG. 1 is a first system block diagram of the present invention.

FIG. 2 is a front view of an electronic device of the present invention.

FIG. 3 is a schematic diagram of the electronic device of the present invention.

FIG. 4 is a second system block diagram of the present invention.

FIG. 5 is a schematic diagram of an operation interface of a user device of the present invention.

FIG. 6 is a third system block diagram of the present invention.

FIG. 7 is a first flowchart of the present invention.

FIG. 8 is a second flowchart of the present invention.

FIG. 9 is a third flowchart of the present invention.

### DETAILED DESCRIPTION OF THE INVENTION

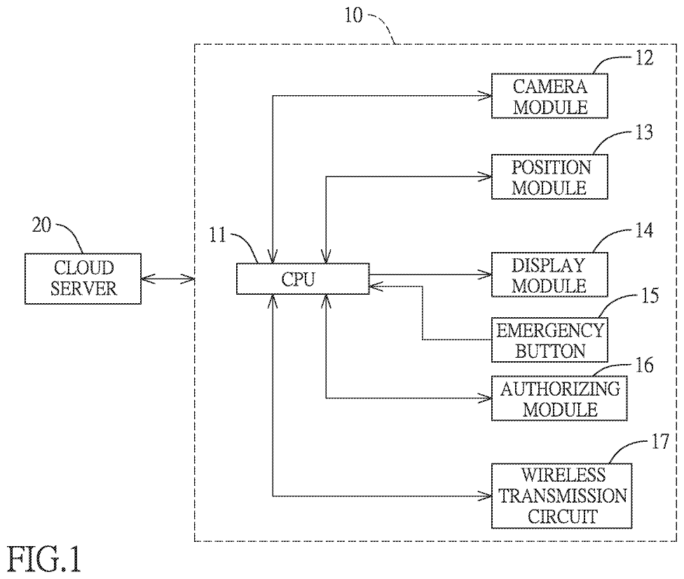

With reference to FIG. 1, the present invention provides a real-time video notification system for a transportation vehicle. The real-time video notification system includes an electronic device 10 mounted on the transportation vehicle, and a cloud server 20.

The electronic device 10 can wirelessly communicate with the cloud server 20. The electronic device 10 includes a central processing unit (CPU) 11, a camera module 12, a position module 13, a display module 14, an emergency button 15, an authorizing module 16, and a wireless transmission circuit 17. In a first embodiment of the real-time video notification system, the electronic device 10 can be a taximeter mounted in the transportation vehicle. The taximeter can measure a time period while carrying a passenger, a distance traveled by the transportation vehicle, and a fee of this trip. The transportation vehicle can be a taxi or other transportation vehicle.

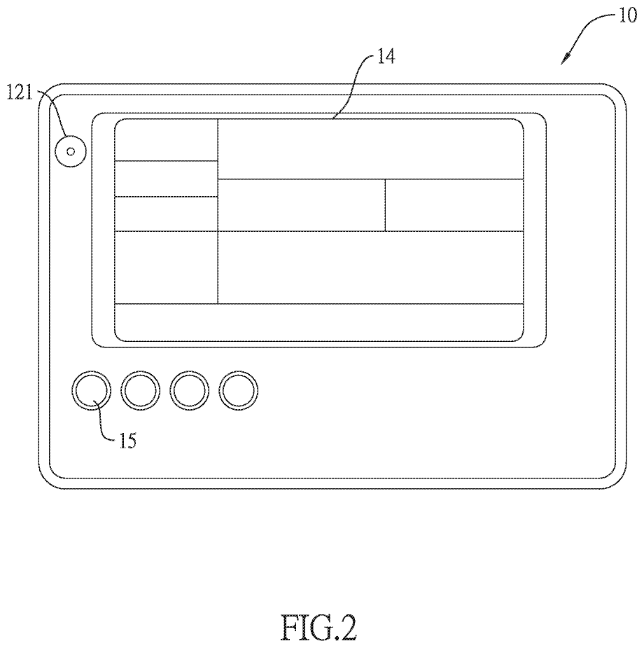

Further reference to FIG. 2, the camera module 12 is electrically connected to the CPU 11, and the camera module 12 includes a camera lens 121. The camera module 12 can capture in-transportation-vehicle images to generate the real-time video information.

The position module 13 is electrically connected to the CPU 11. The position module 13 can detect a position of the electronic device 10, and generate a position signal representative of the current coordinate of the transportation vehicle. In the embodiment of the present invention, the position module 13 is a Global Positioning System (GPS).

The display module 14 is electrically connected to the CPU 11. The display module 14 can display a position of the transportation vehicle, the time period for carrying the passenger, the distance traveled by the transportation vehicle, and the fee of this trip. In the embodiment of the present invention, the display module 14 is a liquid-crystal display (LCD).

The emergency button 15 is electrically connected to the CPU 11. When the emergency button 15 is activated, the CPU 11 can enable the camera module 12 to capture the in-transportation-vehicle images.

The authorizing module 16 is electrically connected to the CPU 11. The authorizing module 16 can generate a first pair signal, and transmit the first pair signal to the cloud server 20 to pair the electronic device 10 with the cloud server 20.

The wireless transmission circuit 17 is electrically connected to the CPU 11, and the wireless transmission circuit 17 can wirelessly connect the electronic device 10 and the cloud server 20. In the embodiment of the present invention, the wireless transmission circuit 17 is a third generation communication module, and the electronic device 10 is wirelessly communicating with the cloud server 20 through the third generation communication technique.

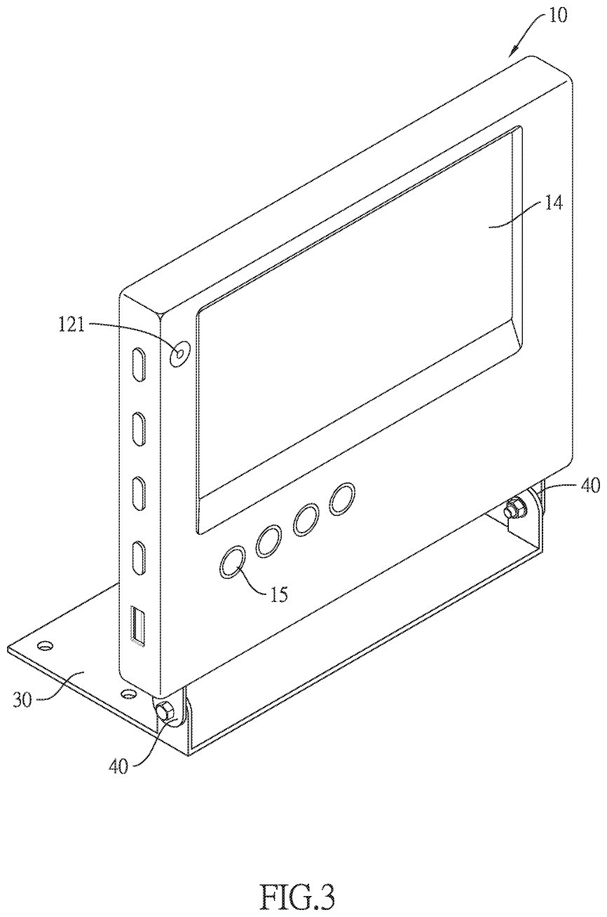

With reference to FIG. 3, in the embodiment of the present invention, the electronic device 10 is connected to a trestle 30. Two mounting parts 40 are formed on a lower portion of the electronic device 10. One terminal of the trestle 30 can be fixed on the two mounting parts 40 with screws, and the other terminal of the trestle 30 is mounted on an inner wall of the transportation vehicle.

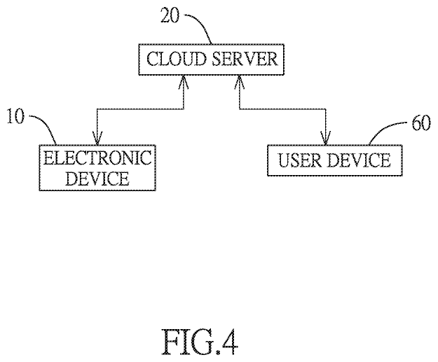

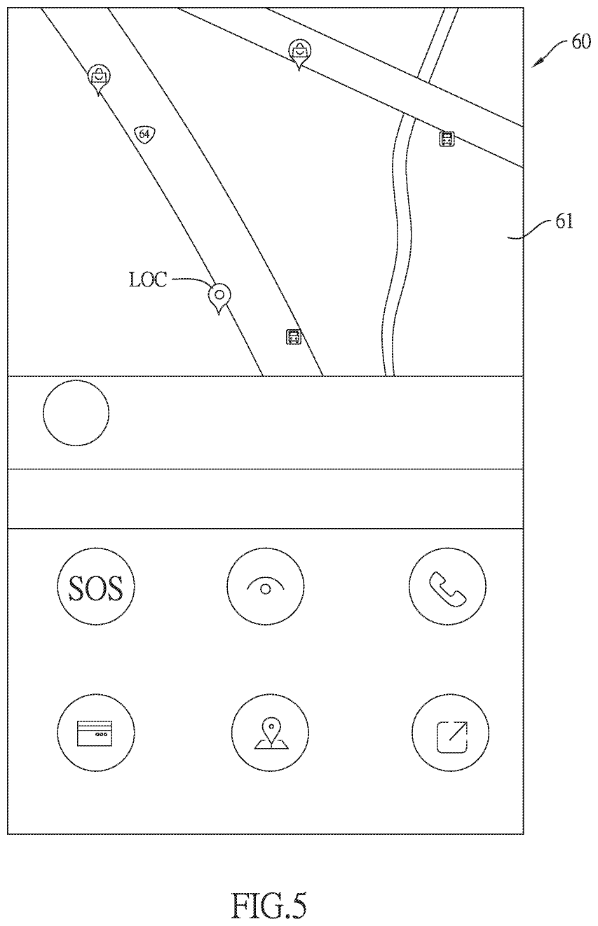

With reference to FIG. 4, in a second embodiment of the real-time video notification system, the real-time video notification system further includes a user device 60. The user device 60 wirelessly communicates with the cloud server 20. The user device 60 can generate a second pair signal, and transmit the second pair signal to the cloud server 20 for pairing the user device 60 and the cloud server 20. Further with reference to FIG. 5, the user device 60 can receive the position signal from the cloud server 20, and an operation interface 61 of the user device 60 can display the position of the transportation vehicle.

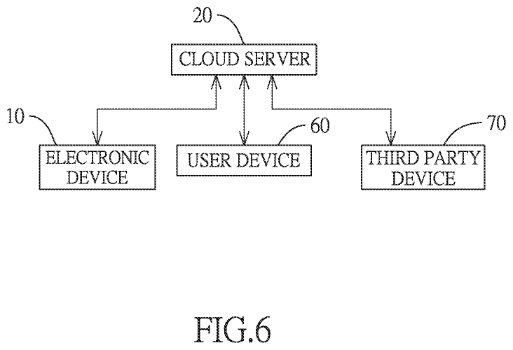

With reference to FIG. 6, in a third embodiment of the real-time video notification system, the real-time video notification system can further include a third-party device 70. The third-party device 70 can wirelessly communicate with the cloud server 20. The third-party device 70 is handled by a third party other than the driver and the passenger. In the embodiment of the present invention, the third party device 70 can be a mobile device, such as a mobile phone or a tablet, of a relative or friend of the passenger, or the third party device 70 may be a device that can be connected to the internet, such as a personal computer or a smart watch, of the relative/friend of the passenger.

The present invention further provides a real-time video notification method for the transportation vehicle. The real-time video notification method is executed by the electronic device 10, the cloud server 20, the user device 60, and the third-party device 70. When the driver or the passenger is encountering the emergency, the camera module 12 of the electronic device 10 can be enabled immediately to capture the in-transportation-vehicle images, and the electronic device 10 can upload the real-time video information to the cloud server 20 to ensure safety of the driver and the passenger.

The real-time video notification method for the transportation vehicle of the present invention includes three embodiments, and the steps of the three embodiments are respectively and sequentially described below.

A first embodiment of the real-time video notification method can be executed by the first embodiment, the second embodiment, and the third embodiment of the real-time video notification system.

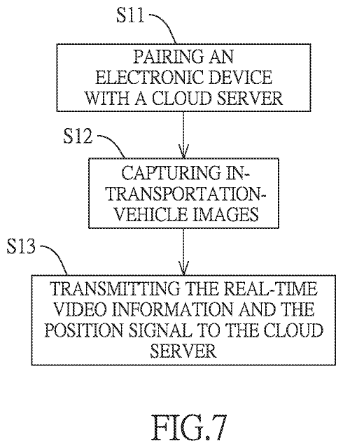

With reference to FIG. 7, the first embodiment of the real-time video notification method includes steps of:

S11: pairing an electronic device 10 with a cloud server 20. The electronic device 10 transmit a first pair signal to the cloud server 20, and the cloud server 20 authorizes pairing information of the electronic device 10 according to the first pair signal. When the cloud server 20 determines that the pairing information of the electronic device 10 is authorized, the electronic device 10 is paired with the cloud server 20.

S12: capturing in-transportation-vehicle images. When an emergency button 15 of the electronic device 10 is activated, the electronic device 10 enables a camera module 12 of the electronic device 10 to capture the in-transportation-vehicle images to generate real-time video information, and the electronic device 10 receives the real-time video information from the camera module 12. The electronic device 10 further generates a position signal when the emergency button 15 is activated.

S13: transmitting the real-time video information and the position signal to the cloud server 20. When the emergency button 15 is activated, the electronic device 10 transmits the real-time video information and the position signal to the cloud server 20.

Moreover, when the emergency button 15 is activated, the electronic device 10 further generates a distress signal. The electronic device 10 uploads the distress signal to the cloud server 20, and the cloud server 20 transmits the position signal, the distress signal, and the real-time video information to a rescue team. Therefore, the rescue team can find where the transportation vehicle is as soon as possible, and help the driver or the passenger.

A second embodiment of the real-time video notification method can be executed by the third embodiment of the real-time video notification system.

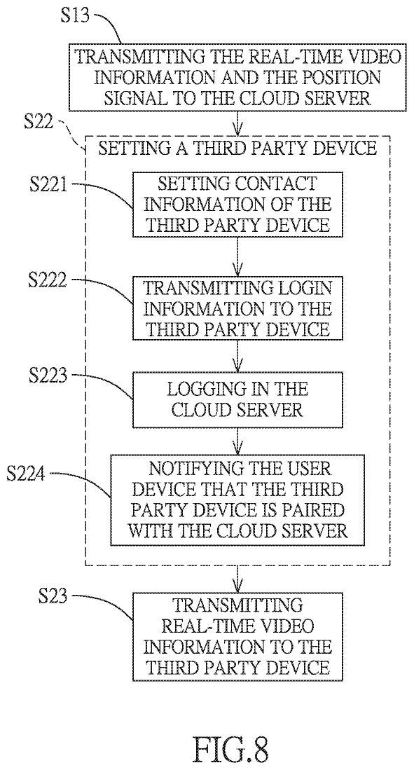

With reference to FIG. 8, in the second embodiment of the real-time video notification method, the passenger can enable the camera module 12 to capture the in-transportation-vehicle images, and the in-transportation-vehicle images can be shared with the third-party device 70, such as a mobile phone and a tablet, of the relatives or the friends. Therefore, the third-party device 70 can play real-time images in the transportation vehicle while the passenger is in the transportation-vehicle. The second embodiment of the real-time video notification method includes steps of:

S21: pairing a cloud server 20 with an electronic device 10 and a user device 60. The electronic device 10 transmits a first pair signal to the cloud server 20, and the cloud server 20 authorizes device pairing information of the electronic device 10 according to the first pair signal. When the cloud server 20 determines that the device pairing information of the electronic device 10 is authorized, the electronic device 10 is paired with the cloud server 20. The user device 30 transmits a second pair signal to the cloud server 20, and the cloud server 20 further authorizes user pairing information of the user device 30 according to the second pair signal. When the cloud server 20 determines that the user pairing information of the user device 30 is authorized, the user device 30 is paired with the cloud server 20.

S22: setting a third-party device 70. The third-party device is set by sub-steps of: S221: setting contact information of the third-party device 70. The user device 30 transmits the contact information of the third-party device 70 to the cloud server 20.

S222: transmitting login information to the third-party device 70. The cloud server 20 receives the contact information, and the cloud server 20 transmits the login information to the third-party device 70. The login information can be a login URL, a combination of a login URL and a login password, or a quick response (QR) code. For example, the cloud server 20 can send a message including the login URL to the third-party device 70.

S223: logging in the cloud server 20. The third-party device 70 receives the login information, and the third-party device 70 logs in the cloud server 20 according to the login information.

S224: notifying the user device 60 that the third-party device 70 is paired with the cloud server 20. When the cloud server 20 determines that the third-party device 70 successfully logs in the cloud server 20, the cloud server 20 transmits a successful paired signal to the user device 60 for notifying the user device 60 that the third-party device 70 is paired with the cloud server 20.

When the third-party device 70 is successfully paired with the cloud server 20, the second embodiment of the real-time video notification method further includes steps of:

S23: transmitting real-time video information to the third-party device 70. When the user device 60 transmits a video sharing signal to the cloud server 20, the cloud server 20 transmits an enabling signal to the electronic device 10, and the electronic device 10 enables a camera module 12 of the electronic device 10 to capture in-transportation-vehicle images to generate the real-time video information according to the enabling signal. The electronic device 10 transmits the real-time video information to the cloud server 20, the cloud server 20 transmits the real-time video information to the third-party device 70, and the third-party device 70 displays the real-time video information.

A third embodiment of the real-time video notification method can be executed by the second embodiment of the real-time video notification system.

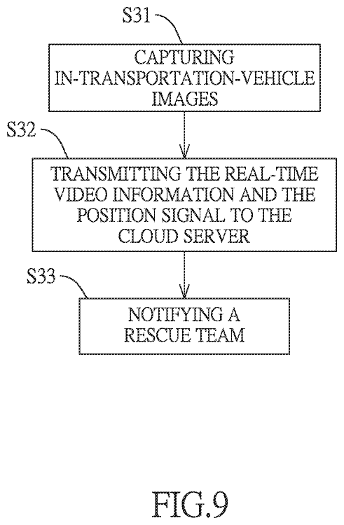

With reference to FIG. 9, in the third embodiment of the real-time video notification method, when the passenger encounters an emergency while in the transportation vehicle, the passenger can use the user device 60 to transmit a distress signal for seeking help.

The third embodiment of the real-time video notification method includes steps of:

S31: capturing in-transportation-vehicle images. When the user device 60 generates an emergency signal, the user device 60 transmits the emergency signal to the cloud server 20. When the cloud server 20 receives the emergency signal, the cloud server 20 communicates with the electronic device 10 to enable the camera module 12 of the electronic device 10, the camera module 12 captures the in-transportation-vehicle images to generate the real-time video information, and the electronic device 10 generates a position signal.

S32: transmitting the real-time video information and the position signal to the cloud server 20. When the electronic device 10 receives the real-time video information from the camera module 12 and generates the position signal, the electronic device 10 transmits the real-time video information and the position signal to the cloud server 20.

S33: notifying a rescue team. When the camera module 12 is enabled by the cloud server 20, the electronic device 10 further generates a distress signal, and the electronic device 10 uploads the distress signal to the cloud server 20. The cloud server 20 transmits the position signal, the distress signal, and the real-time video information to the rescue team. Therefore, the rescue team can find where the transportation vehicle is as soon as possible, and help the driver or the passenger.

The passenger can use the user device 60, such as a mobile phone, to communicate with the cloud server 20 and the electronic device 10. When the driver or the passenger encounters the emergency, the driver or the passenger can actively seek help by enabling the electronic device 10 to generate the distress signal, and the rescue team can find where the transportation vehicle is as soon as possible to help the driver or the passenger. Moreover, the third-party device 70 can play real-time video from the transportation vehicle while the passenger is in the transportation-vehicle. Therefore, when the driver or the passenger cannot seek help on their own, the third party using the third-party device 70 can seek help on behalf of the driver or the passenger to allow more rescue time for the rescue team.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. (canceled)

2. (canceled)

3. A real-time video notification method for a transportation vehicle, comprising steps of:
(b1) pairing a cloud server with an electronic device and a user device; wherein the electronic device transmits a first pair signal to the cloud server, and the cloud server authorizes device pairing information of the electronic device according to the first pair signal; wherein when the cloud server determines that the device pairing information of the electronic device is authorized, the electronic device is paired with the cloud server; wherein the user device transmits a second pair signal to the cloud server, and the cloud server authorizes user pairing information of the user device according to the second pair signal; wherein when the cloud server determines that the user pairing information of the user device is authorized, the user device is paired with the cloud server;
(b2) setting a third-party device; wherein the third party device is set by sub-steps of:
(b21) setting contact information of the third-party device; wherein the user device transmits the contact information of the third-party device to the cloud server;
(b22) transmitting login information to the third-party device; wherein the cloud server receives the contact information, and the cloud server transmits the login information to the third party device;
(b23) logging in the cloud server; wherein the third-party device receives the login information, and the third-party device logs in the cloud server according to the login information; and
(b24) notifying the user device that the third-party device is paired with the cloud server; wherein when the cloud server determines that the third party device successfully logs in the cloud server, the cloud server transmits a successful paired signal to the user device for notifying the user device that the third party device is paired with the cloud server; and
(b3) transmitting real-time video information to the third party device; wherein when the user device transmits a video sharing signal to the cloud server, the cloud server transmits an enabling signal to the electronic device, and the electronic device enables a camera module of the electronic device to capture in-transportation-vehicle images to generate the real-time video information according to the enabling signal; wherein the electronic device transmits the real-time video information to the cloud server, the cloud server transmits the real-time video information to the third party device, and the third party device displays the real-time video information.

4. The real-time video notification method for the transportation vehicle as claimed in claim 3, further comprising step of:
capturing the in-transportation-vehicle images; wherein when an emergency button of the electronic device is activated, the electronic device enables a camera module of the electronic device to capture the in-transportation-vehicle images to generate the real-time video information, and the electronic device receives the real-time video information from the camera module; wherein the electronic device further generates a position signal when the emergency button is activated;
transmitting the real-time video information and the position signal to the cloud server; wherein when the emergency button is activated, the electronic device transmits the real-time video information and the position signal to the cloud server.

5. The real-time video notification method for the transportation vehicle as claimed in claim 4, further comprising steps of:
notifying a rescue team; wherein when the electronic device generates a distress signal, the electronic device uploads the distress signal to the cloud server; wherein the cloud server transmits the position signal, the distress signal, and the real-time video information to the rescue team.

6. A real-time video notification system for a transportation vehicle, comprising:
a cloud server;
an electronic device, wirelessly communicating with the cloud server;
wherein the electronic device includes:
a central processing unit (CPU);
a camera module, electrically connected to the CPU to capture in-transportation-vehicle images, and generating real-time video information;
an authorizing module, electrically connected to the CPU to generate a first pair signal, and transmitting the first pair signal to the cloud server; wherein the cloud server receives the first pair signal, and the cloud server authorizes device pairing information of the electronic device according to the first pair signal;
a position module, electrically connected to the CPU to generate a position signal;
an emergency button, electrically connected to the CPU; wherein when the emergency button is activated, the CPU enables the camera module to capture the in-transportation-vehicle images; and
a wireless transmission circuit, electrically connected to the CPU, and wirelessly connecting the electronic device with the cloud server; wherein when the emergency button is activated, the electronic device transmits the real-time video information, the first pair signal, and the position signal to the cloud server through the wireless transmission circuit;
wherein the cloud server further wirelessly communicates with a user device;
wherein the user device generates a second pair signal, and transmits the second pair signal to the cloud server;
wherein the cloud server further authorizes user pairing information of the user device according to the second pair signal;
wherein when the cloud server determines that the user pairing information of the user device is authorized, the user device is paired with the cloud server;
wherein the user device transmits an emergency signal to the cloud server;
wherein when the cloud server receives the emergency signal, the cloud server; communicates with the electronic device to enable the camera module of the electronic device, the camera module captures the in-transportation-vehicle images to generate the real-time video information, and the electronic device generates a position signal;
wherein the user device transmits contact information of the third party device to the cloud server, the cloud server receives the contact information, and the cloud server transmits login information to the third party device;
wherein when the third party device receives the login information, the third party device logs in the cloud server according to the login information; and
wherein when the cloud server determines that the third party device successfully logs in the cloud server, the cloud server transmits a successful paired signal to the user device.

7. (canceled)

8. (canceled)

9. (canceled)

10. The real-time video notification system for the transportation vehicle as claimed in claim 6, wherein when the user device transmits a video sharing signal to the cloud server, the cloud server transmits an enabling signal to the electronic device, and the electronic device enables a camera module of the electronic device to capture the in-transportation-vehicle images to generate the real-time video information according to the enabling signal; wherein the electronic device transmits the real-time video information to the cloud server, and the cloud server transmits the real-time video information to the third party device.
